(19) United States
(12) Patent Application Publication
(10) Pub. No.: US 2026/0254224 A1
(43) Pub. Date: Aug. 27, 2026

(54) CIRCUIT BREAKER DEVICE AND METHOD

(71) Applicant: Siemens Aktiengesellschaft, München (DE)

(72) Inventors: Marvin Tannhäuser, Hausen (DE); Felix Frei, Marienberg OT Zöblitz (DE)

(21) Appl. No.: 19/160,121

(22) PCT Filed: Jan. 18, 2024
(86) PCT No.: PCT/EP2024/051114

§ 371 Date: Aug. 27, 2025

(30) Foreign Application Priority Data
Feb. 27, 2023 (DE) 10 2023 201 777.6

(51) Int. Cl. H02H 1/00; H01H 3/04; H01H 9/16; H01H 9/54; H02H 3/02; H02H 3/10; H02H 3/20; H02H 3/24

(52) U.S. Cl. CPC H02H 1/0061; H01H 3/04; H01H 9/167; H01H 9/548; H02H 3/021; H02H 3/105; H02H 3/20; H02H 3/24

(57) ABSTRACT

A circuit breaker device protects a low-voltage circuit and has a mechanical isolator contact unit connected to an electronic disconnection unit in series. The serial circuit is connected to a grid-side and to a load-side connection. The mechanical isolator contact unit is switched by opening contacts to prevent a current flow in the low-voltage circuit or by closing the contacts to enable a current flow. The electronic disconnection unit is switched, by semiconductor-based switch elements, to a high-ohmic state in order to prevent a current flow in the low-voltage circuit, or to a low-ohmic state of the switch elements to enable a current flow. A level of the current in the low-voltage circuit is ascertained and a process for preventing a current flow is initiated if current thresholds and/or current/time thresholds are exceeded. A high-ohmic or low-ohmic state of the electronic disconnection unit is signaled via a signaling output.

The invention relates to the technical field of a circuit breaker device for a low-voltage circuit having an electronic interruption unit and to a method for a circuit breaker device for a low-voltage circuit having an electronic interruption unit.

Low voltage is understood to mean voltages of up to 1000 volts AC or up to 1500 volts DC. Low voltage is understood in particular to mean voltages that are greater than extra-low voltage, with values of 50 volts AC or 120 volts DC.

A low-voltage circuit or grid or installation is understood to mean circuits with nominal currents or rated currents of up to 125 amperes, more specifically up to 63 amperes. A low-voltage circuit is understood to mean in particular circuits with nominal currents or rated currents of up to 50 amperes, 40 amperes, 32 amperes, 25 amperes, 16 amperes or 10 amperes. Said current values are understood to mean in particular nominal, rated or/and shutdown currents, that is to say the maximum current that is normally carried through the circuit or in the case of which the electrical circuit is usually interrupted, for example by a protection device, such as a circuit breaker device, miniature circuit breaker or power circuit breaker. The nominal currents may be staggered further, from 0.5 A through 1 A, 2 A, 3 A, 4 A, 5 A, 6 A, 7 A, 8 A, 9 A, 10 A, etc. up to 16 A.

Miniature circuit breakers are overcurrent protection devices that have long been known and that are used in low-voltage circuits in electrical installation engineering. They protect lines against damage caused by heating due to excessively high current and/or a short circuit. A miniature circuit breaker may automatically shut down the circuit in the event of an overload and/or short circuit. A miniature circuit breaker is not a safety element that resets automatically.

In contrast to miniature circuit breakers, power circuit breakers are intended for currents greater than 125 A, in some cases also starting from 63 amperes. Miniature circuit breakers therefore have a simpler and more delicate design. Miniature circuit breakers usually have a fastening option for fastening to a so-called top-hat rail (carrier rail, DIN rail, TH35).

Miniature circuit breakers have an electromechanical design. In a housing, they have a mechanical switching contact or operating current tripping device for interrupting (tripping) the electric current. A bimetal protection element or bimetal element is usually used for tripping (interruption) in the event of a sustained overcurrent (overcurrent protection), respectively in the event of a thermal overload (overload protection). An electromagnetic tripping device with a coil is used for brief tripping in the event of an overcurrent limit value being exceeded or in the event of a short circuit (short circuit protection). One or more arc extinguishing chambers or arc extinguishing devices are provided. Connection elements for conductors of the electrical circuit to be protected are also provided.

Circuit breaker devices having an electronic interruption unit are relatively recent developments. They have a semiconductor-based electronic interruption unit. In other words, the electric current flow in the low-voltage circuit is guided via semiconductor components or semiconductor switches that are able to interrupt the electric current flow or are able to be switched to the on state. Circuit breaker devices having an electronic interruption unit often also have a mechanical isolating contact unit, in particular with isolator properties in accordance with the applicable standards for low-voltage circuits, wherein the contacts of the mechanical isolating contact unit are connected in series with the electronic interruption unit, that is to say the current of the low-voltage circuit to be protected is guided both through the mechanical isolating contact unit and through the electronic interruption unit.

The present invention may be used both for low-voltage DC circuits and for low-voltage AC circuits. The invention relates in particular to low-voltage AC circuits having an AC voltage, usually having a time-dependent sinusoidal AC voltage of frequency f. The temporal dependency of the instantaneous voltage value u(t) of the AC voltage is described by the equation:

$$u ( t ) = U * sin ( 2 π * f * t ) ,$$

wherein:
u(t)=instantaneous voltage value at the time t
U=amplitude of the voltage

A harmonic AC voltage may be represented by the rotation of a vector the length of which corresponds to the amplitude (U) of the voltage. The instantaneous deviation is in this case the projection of the vector onto a coordinate system. An oscillation period corresponds to a full revolution of the vector and its full angle is 2π (2pi) or 360°. The angular frequency is the rate of change of the phase angle of this rotating vector. The angular frequency of a harmonic oscillation is always 2π times its frequency, that is to say:
ω=2π*f=2π/T=angular frequency of the AC voltage
(T=period duration of the oscillation).

It is often preferred to give the angular frequency (ω) rather than the frequency (f), since many formulae in oscillation theory are able to be represented more compactly using the angular frequency due to the occurrence of trigonometric functions the period of which is by definition 2π:

$$u ( t ) = U * sin ( ω t )$$

In the case of non-temporally constant angular frequencies, the term instantaneous angular frequency is also used.

In the case of a sinusoidal, in particular temporally constant, AC voltage, the time-dependent value formed from the angular velocity ω and time t corresponds to the time-dependent angle φ(t), which is also referred to as phase angle φ(t). In other words, the phase angle φ(t) periodically runs through the range 0 . . . 2π or 0° . . . 360°. In other words, the phase angle periodically adopts a value between 0 and 2π or 0° and 360° (φ=n*(0 . . . 2π) or φ=n*(0° . . . 360°), owing to periodicity; for short: φ=0 . . . 2π or φ=0° . . . 360°).

Instantaneous voltage value u(t) is therefore understood to mean the instantaneous value of the voltage at the time t, that is to say, in the case of a sinusoidal (periodic) AC voltage, the value of the voltage at the phase angle φ(φ=0 . . . 2π or φ=0° . . . 360°, of the respective period).

The object of the present invention is to improve a circuit breaker device of the type mentioned at the outset, in particular to achieve greater flexibility and a novel feature for the circuit breaker device.

This object is achieved by a circuit breaker device having the features of patent claim 1, and by a method as claimed in patent claim 13.

According to the invention, what is proposed is a circuit breaker device for protecting an electrical low-voltage circuit, in particular low-voltage AC circuit, having:
a housing having at least one grid-side connection and at least one load-side connection, both for conductors of the low-voltage circuit that are to be connected to the circuit breaker device,
a mechanical isolating contact unit that is connected in series with an electronic interruption unit, wherein the series circuit is connected to the at least one grid-side connection, on the one hand, and to the at least one load-side connection, on the other hand,
wherein the mechanical isolating contact unit is able to be switched by opening at least one contact so as to avoid a current flow or closing the at least one contact to allow a current flow in the low-voltage circuit,
wherein the electronic interruption unit is able to be switched by semiconductor-based switching elements to a high-resistance state of the switching elements so as to avoid a current flow or a low-resistance state of the switching elements so as to allow a current flow in the low-voltage circuit,
a current sensor unit for ascertaining the level of the current in the low-voltage circuit,
a control unit that is connected to the current sensor unit, the mechanical isolating contact unit and the electronic interruption unit, wherein, in the event of current or/and current-time limit values being exceeded, avoidance of a current flow in the low-voltage circuit is initiated. According to the invention, a signaling output is provided on the circuit breaker device. The signaling output is in particular accessible on the housing of the circuit breaker device. The signaling output is in particular connected to the control unit.

The circuit breaker device is designed such that the signaling output signals, or is able to signal, a high-resistance or low-resistance state of the electronic interruption unit (signals or able to signal is understood to mean, inter alia, able to transmit, able to transfer, able to send; information regarding the state is transmitted). This has the advantage that provision is made for a signaling output that is integrated in or on the circuit breaker device and that is able to be used to signal the state of the electronic interruption unit explicitly, without further modifications or attachments on the circuit breaker device and without an external additional device. This saves on room and installation space in a distribution box of an electrical distribution.

Further advantageous embodiments of the invention are indicated in the dependent claims and in the exemplary embodiment.

In one advantageous embodiment of the invention, the mechanical isolating contact unit is assigned to the load-side connection and the electronic interruption unit is assigned to the grid-side connection. The mechanical isolating contact unit is in particular able to be operated using a mechanical handle in order to switch between opening the at least one contact or closing the at least one contact.

This has the particular advantage of providing a structure for a circuit breaker device in which the circuit breaker device is functional even when the contacts of the mechanical isolating contact unit are open.

In one advantageous embodiment of the invention, provision is made for two grid-side connections and at least one load-side connection. Provision is made in particular for a grid-side phase conductor connection, a grid-side neutral conductor connection and a load-side phase conductor connection.

This has the particular advantage of providing a structure for a circuit breaker device in which there is a supply of power to the circuit breaker device, on the one hand, and a space-saving device is made possible by only one switched pole, on the other hand.

In one advantageous embodiment of the invention, provision is made for two grid-side connections and two load-side connections. Provision is made in particular for a grid-side neutral conductor connection, a grid-side phase conductor connection, a load-side neutral conductor connection and a load-side phase conductor connection.

This has the particular advantage of providing a structure for a two-pole circuit breaker device such that the phase and neutral conductor are able to be connected directly and, for example, further neutral conductor rails are able to be dispensed with.

In one advantageous embodiment of the invention, the signaling output has in particular safe galvanic isolation.

Safe galvanic isolation may be implemented for example by way of an optocoupler or relay, or alternatively by inductive or capacitive galvanic isolation.

This has the particular advantage that the signaling output is able to be used universally at a floating potential or of providing safe galvanic isolation with respect to the phase conductors (or with respect to the control unit). Since the phase conductors (or the control unit) are at grid voltage (for example 230 V (AC)) during operation, this galvanic isolation enables safe use of the signaling output. This in particular enables protection against an electric shock or so-called “accidental energization” of a connected electrical line and the devices connected thereto. In the event of accidental energization, an electrical potential is unintentionally transferred to an electrical line or another device.

In one advantageous embodiment of the invention, the signaling output also signals an open or closed state of the at least one contact of the mechanical isolating contact unit.

This has the particular advantage of providing further flexibility and a functional enhancement of the circuit breaker device.

In one advantageous embodiment of the invention, the signaling output is accessible on the housing side. The signaling output in particular has multiple connection terminals, in particular two or three connection terminals, wherein the connection terminals are connected, inside the circuit breaker device, to at least one optocoupler/to the output side of the optocoupler. The input side of the optocoupler is for example connected to the control unit, which outputs a corresponding signal.

As an alternative, the connection terminals or, in addition, further connection terminals are connected to an in particular floating relay contact.

This has the particular advantage of providing a simple option for a floating connection of the signaling output.

In one advantageous embodiment of the invention, provision is made for a display unit that is connected to the control unit and that has display means, visible on the circuit breaker device, for displaying the high-resistance or low-resistance state of the electronic interruption unit. This has the particular advantage of providing visualization of the state of the electronic interruption unit.

In one advantageous embodiment of the invention, the circuit breaker device is designed such that the signaling output is configurable, more specifically that the signaling output, in addition to signaling a high-resistance or low-resistance state of the electronic interruption unit, or as an alternative thereto, also signals:
a) the presence of an (electrical) fault on the load-side connection and/or
b) the presence of a fault inside the circuit breaker device.

This has the particular advantage of providing further flexibility and a functional enhancement of the circuit breaker device.

An (electrical) fault is understood to mean, inter alia, a:
short circuit
overload/overcurrent
fault current
serial arc
   (depending on the design or/and configuration of the circuit breaker device).

A fault inside the circuit breaker device is understood to mean, inter alia, a:
defect in the electronic interruption unit
defect in the current sensor unit or voltage sensor unit
defect in electronic components outside the control unit.

The signaling output, in addition to signaling a high-resistance or low-resistance state of the electronic interruption unit, or as an alternative thereto, may additionally also provide:
a display of a device status (ON or OFF or Standby).

The signaling output, in addition to signaling a high-resistance or low-resistance state of the electronic interruption unit, or as an alternative thereto, may additionally also:
display a configurable warning, such as:
   overvoltage, undervoltage,
   excessively high temperature, excessively low temperature,
   overcurrent (exceedance of a current value that is defined or able to be defined by a user),
   exceedance of a fault current threshold (ground fault current monitoring/RCM function).

In one advantageous embodiment of the invention, the circuit breaker device is designed such that an (electrical) fault on the load-side connection is:
a) a short circuit (of the consumer/of the (external) conductors of the low-voltage circuit that are connected to the circuit breaker device) or/and
b) an overload (of the consumer/of the (external) conductors of the low-voltage circuit that are connected to the circuit breaker device),
or alternatively or additionally
c) a ground fault current
or alternatively or additionally
d) a serial fault arc.

A fault inside the circuit breaker device is:
a) an excessively high device temperature or/and
b) a defect with a component of a unit of the circuit breaker device or/and
c) an (internal) current threshold value being exceeded (or fallen below) or/and
d) an (internal) voltage threshold value being fallen below (or exceeded).

A defect with a component of a unit of the circuit breaker device may for example be an (internally) identified defect with the electronic interruption unit. This may be ascertained for example by briefly switching on and off or switching off and on with simultaneous measurement of electrical variables, such as current and voltage.

A fault may for example be the fact that an (internal) voltage threshold value is fallen below, for example when the voltage (RMS value) at the grid-side connections (or at the power supply of the circuit breaker device/power supply unit) is so low that correct operation of the circuit breaker device is no longer ensured.

This has the particular advantage of providing further flexibility and a functional enhancement of the circuit breaker device, in particular of enabling improved signaling (or communication) of various states (or faults).

This increases and simplifies the communication capabilities of the device. This signaling output furthermore provides a wired communication interface (in particular a two-pole/two-wire wired communication interface), so as to provide virtually delay-free signaling by way of the signaling output (latency-free). Virtually delay-free is understood 6 to mean direct signaling (signaling contact closed/open or in the low-resistance/high-resistance state), that is to say without overhead information processing, as occurs for example in principle in the case of LAN/WLAN connections, due to communication protocols, which use for example MAC addresses, TCP/IP communication or OSI communication. Depending on the field of use or application of the circuit breaker device, the signaling output may thus be adapted and used for different functions.

In one advantageous embodiment of the invention, the circuit breaker device is designed such that the signaling output is able to adopt two switching states, which May also be output as a (switching) sequence, such that it is possible to output multiple items of information via the signaling output, which in particular has two poles/two connection terminals.

This has the particular advantage of providing a further functional enhancement of the circuit breaker device, in particular of enabling enhanced signaling of different states.

By way of example, an applied continuous logic zero level (logic zero level typically means that the signaling output is at zero volts or in the low-resistance state) signals that the circuit breaker device is in the on state (ON). An applied continuous logic one level (logic one level typically means that the signaling output is at 12 volts or 5 volts (or other typical signaling voltages) or is in the high-resistance state) signals that the circuit breaker device is in the Standby state or off state (OFF). If the signal levels change, for example at a frequency of 0.5 Hz, this may for example signal a fault. In this case, a device state is thus no longer signaled, but rather it is signaled that for example an external fault/fault on the load-side connection or a fault inside the circuit breaker device is present.

In one advantageous embodiment of the invention, checking functions on the circuit breaker device side that
a) switch the electronic interruption unit, which is in the high-resistance state, to the low-resistance state for a first time period or (and)
b) switch the electronic interruption unit, which is in the low-resistance state, to the high-resistance state for a second time period
are not signaled by the signaling output.

In other words, the checking functions that bring about a (brief) state change of the electronic interruption unit are not signaled via the signaling output. In other words, the state change (brought about by the checking function) of the electronic interruption unit is not signaled by way of the signaling output.

This has the particular advantage of avoiding “flickering” of the signaling output (“flickering” of the (signaled) state of the signaling output) of the circuit breaker device. Downstream evaluation units connected to the signaling output are thus not “disturbed” by such (brief) state changes, that is to say the connected devices do not receive incorrect information about the device state or the device status, and in particular the status of the electronic interruption unit. The checking functions may be carried out regularly or else irregularly. The checking functions bring about, inter alia, a brief state change of the electronic interruption unit, that is to say the situation whereby the electronic interruption unit is briefly in the low-resistance or high-resistance state. The checking 6 functions are intended to ensure functional reliability of the circuit breaker device, in particular including during (regular) operation of the circuit breaker device.

The first time period is for example a short time period in the range of μs or ms up to one second, such as for example 100 μs . . . 200 μs . . . 300 μs . . . 600 μs . . . 700 μs . . . 800 μs . . . 1 ms . . . 10 ms . . . 20 ms . . . 40 ms . . . 50 ms . . . 100 ms . . . 200 ms . . . 500 ms . . . 1 s (any intermediate value possible).

The second time period is for example a short time period in the range of us or ms up to one second, such as for example 100 μs . . . 200 μs . . . 300 μs . . . 600 μs . . . 700 μs . . . 800 μs . . . 1 ms . . . 10 ms . . . 20 ms . . . 40 ms . . . 50 ms . . . 100 ms . . . 200 ms . . . 500 ms . . . 1 s (any intermediate value possible).

According to the invention, what is claimed is a corresponding method for a circuit breaker device for a low-voltage circuit having electronic (semiconductor-based) switching elements having the same and further advantages.

The method for a circuit breaker device for protecting an electrical low-voltage circuit having:
a mechanical isolating contact unit that is connected in series with an electronic interruption unit, wherein the series circuit is connected to at least one grid-side connection, on the one hand, and to at least one load-side connection, on the other hand,
wherein the mechanical isolating contact unit is able to be switched by opening contacts so as to avoid a current flow or closing the contacts to allow a current flow in the low-voltage circuit,
wherein the electronic interruption unit is able to be switched by semiconductor-based switching elements to a high-resistance state of the switching elements so as to avoid a current flow or a low-resistance state of the switching elements so as to allow a current flow in the low-voltage circuit,
wherein the level of the current in the low-voltage circuit is ascertained and, in the event of current or/and current-time limit values being exceeded, avoidance of a current flow in the low-voltage circuit is initiated,
wherein a high-resistance or low-resistance state of the electronic interruption unit is signaled via a signaling output.

In one advantageous embodiment of the invention, the signaling output is able to adopt (at least) two states, which may also in particular be output as a switching sequence, such that it is possible to output multiple items of information via the signaling output, which in particular has two poles/two connection terminals.

All embodiments, both in dependent form referring back to independent patent claims 1 and 13 and referring back only to individual features or combinations of features of patent claims, in particular including a back-reference in the dependent arrangement claims to the independent method claim, bring about an improvement to a circuit breaker device, in particular an improvement in functionality, and provide a novel concept for a circuit breaker device.

The described properties, features and advantages of this invention and the way in which these are achieved will become clearer and more clearly comprehensible in connection with the following description of the exemplary embodiments, which are explained in more detail in connection with the drawing.

Here, in the drawing:

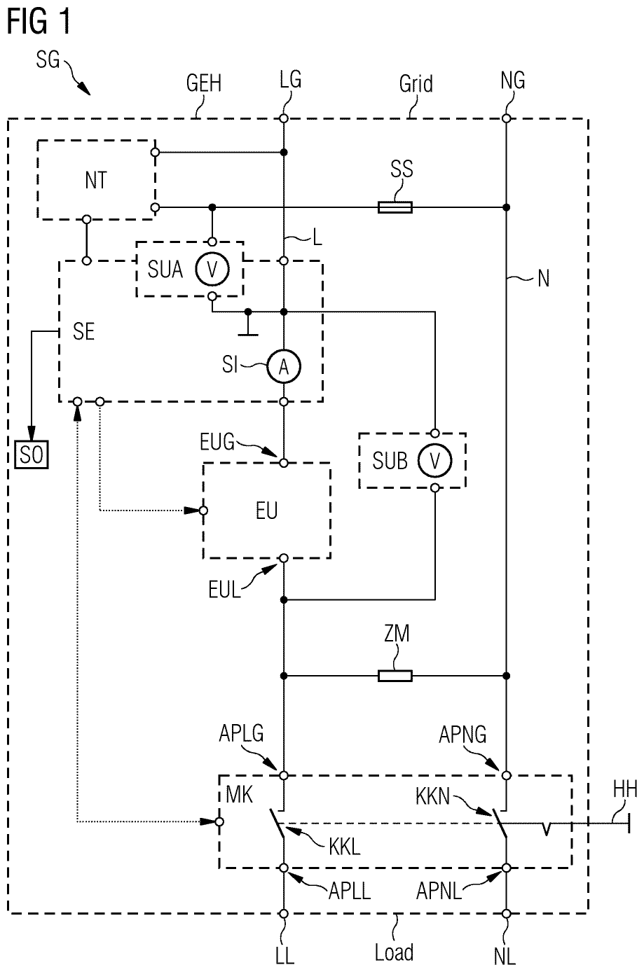

FIG. 1 shows a first illustration of a circuit breaker device,

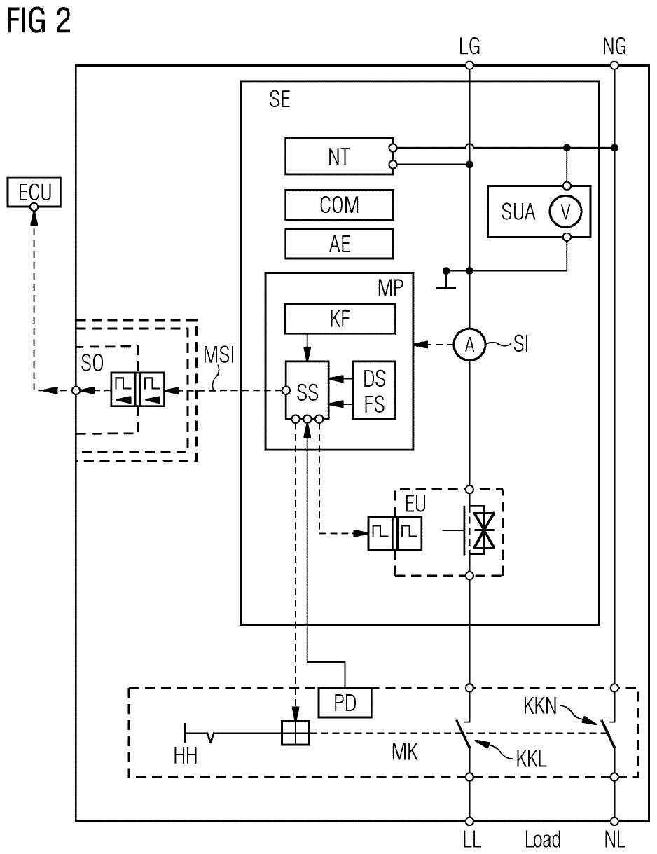

FIG. 2 shows a second illustration of a circuit breaker device,

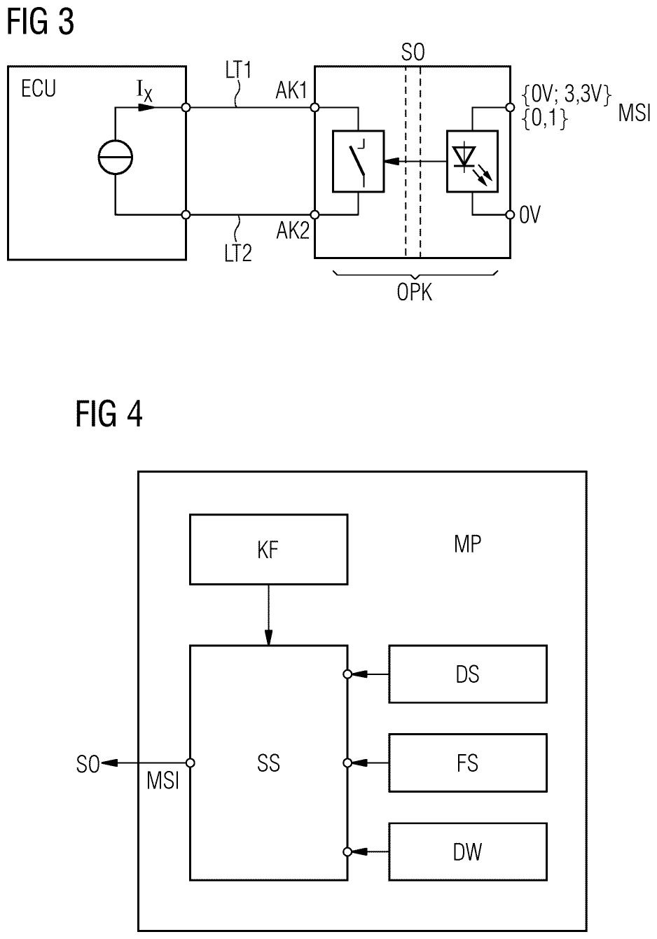

FIG. 3 shows an illustration of a signaling output,

FIG. 4 shows an illustration of a function group,

FIG. 5 shows an illustration of a configuration,

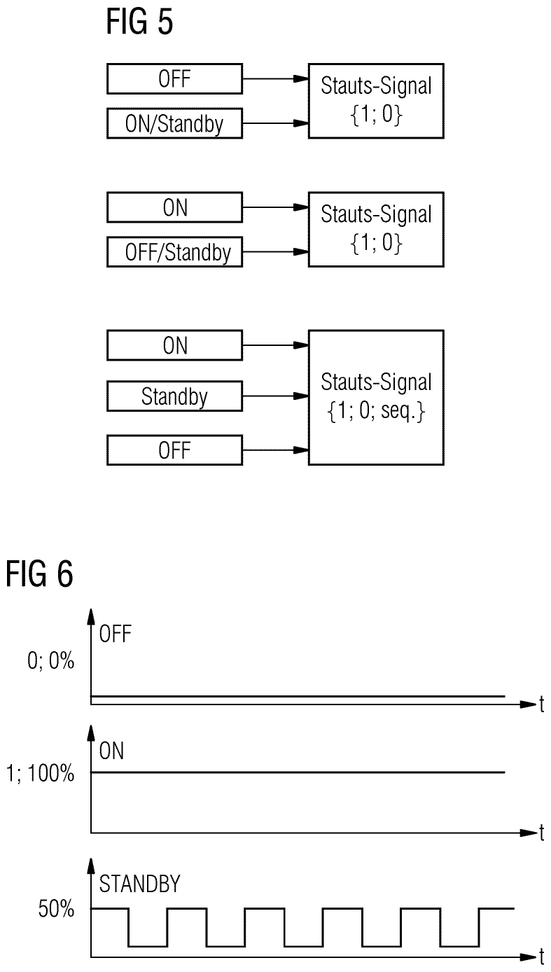

FIG. 6 shows a first illustration of switching states over time,

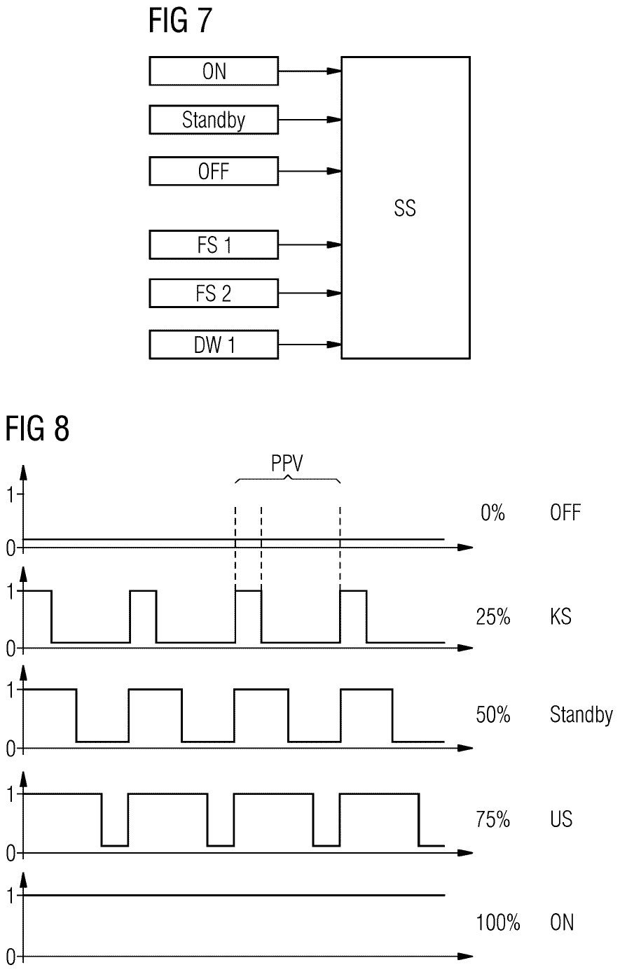

FIG. 7 shows an illustration of a status signal function,

FIG. 8 shows a second illustration of switching states over time.

FIG. 1 shows an illustration of a circuit breaker device SG for protecting an electrical low-voltage circuit, in particular low-voltage AC circuit, having a housing GEH, having:
a grid-side neutral conductor connection NG, a grid-side phase conductor connection LG, a load-side neutral conductor connection NL, a load-side phase conductor connection LL of the low-voltage circuit;
a power source is usually connected to the grid side Grid, a consumer is usually connected to the load side Load;
a (two-pole) mechanical isolating contact unit MK having load-side connection points APLL, APNL and grid-side connection points APLG, APNG,
wherein a load-side connection point APNL is provided for the neutral conductor, a load-side connection point APLL is provided for the phase conductor, a grid-side connection point APNG is provided for the neutral conductor, and a grid-side connection point APLG is provided for the phase conductor. The load-side connection points APNL, APLL are connected to the load-side neutral and phase conductor connections NL, LL such that it is possible to switch between opening contacts KKN, KKL so as to avoid a current flow or closing the contacts to allow a current flow in the low-voltage circuit,
the mechanical isolating contact unit may also be designed as a single-pole mechanical isolating contact unit, that is to say with one contact, wherein the contact KKL is preferably arranged in the phase conductor L, and a neutral conductor N that goes through the circuit breaker device SG is then not provided,
an in particular single-pole electronic interruption unit EU (which is in particular arranged in the phase conductor L in the single-pole design),
having a grid-side connecting point EUG that is electrically connected to the grid-side phase conductor connection LG, and
a load-side connecting point EUL that is connected or electrically connected to the grid-side connection point APLG of the mechanical isolating contact unit MK,
wherein the electronic interruption unit, as a result of semiconductor-based switching elements, has a high-resistance state of the switching elements so as to avoid a current flow or a low-resistance state of the switching elements so as to allow a current flow in the low-voltage circuit,
a current sensor unit SI for ascertaining the level of the current in the low-voltage circuit, which is arranged in particular in the phase conductor L,
a control unit SE that is connected to the current sensor unit SI, the mechanical isolating contact unit MK and the electronic interruption unit EU, wherein, in the event of current and/or current-time limit values being exceeded, avoidance of a current flow in the low-voltage circuit is initiated.

According to the invention, the circuit breaker device SG is designed such that provision is made for a signaling output SO that is accessible on the housing GEH of the circuit breaker device SG. The signaling output SO is in particular connected to the control unit SE.

The circuit breaker device is designed such that the signaling output SO signals a high-resistance or low-resistance state of the electronic interruption unit EU. Provision may furthermore be made for a first voltage sensor unit SUA that is connected to the control unit SE and that ascertains the level of the voltage, in particular instantaneous values of the level of the voltage, of the low-voltage circuit, in particular at the grid-side connections LG, NG, specifically between the grid-side neutral conductor connection NG and the grid-side phase conductor connection LG.

Generally speaking, the mechanical isolating contact unit MK and the electronic interruption unit EU form a series circuit. The series circuit is connected to the at least one grid-side connection, on the one hand, and to the at least one load-side connection, on the other hand. The mechanical isolating contact unit MK may advantageously be assigned to the load-side connection, and the electronic interruption unit EU may be assigned to the grid-side connection, as illustrated in FIG. 1. The mechanical isolating contact unit MK may be able to be operated using a mechanical handle HH in order to switch between opening contacts or closing the contacts, as in the case of a conventional miniature circuit breaker (MCB).

The control unit SE may have a microcontroller MP (microcontroller unit) (as illustrated in FIG. 2).

Provision may furthermore be made for a second voltage sensor unit SUB that is connected to the control unit SE and that ascertains the level of the voltage between the grid-side connecting point EUG and the load-side connecting point EUL of the electronic interruption unit EU.

A measurement impedance ZM may be connected between the grid-side connection points APLG, APNG of the mechanical isolating contact unit MK. The measurement impedance ZM May for example be an electrical resistor or/and capacitor. The measurement impedance may furthermore be an inductor. The measurement impedance may in particular be a series circuit or parallel circuit of a resistor or/and capacitor or/and inductor.

In the example according to FIG. 1, the electronic interruption unit EU is of single-pole design, in the phase conductor in the example. In this case, the grid-side connection point APNG for the neutral conductor of the mechanical isolating contact unit MK is connected to the grid-side neutral conductor connection NG of the housing GEH. In a single-pole variant, this connection may be dispensed with, as may the neutral conductor contact KKN of the mechanical isolating contact unit.

The circuit breaker device SG is advantageously designed such that the contacts of the mechanical isolating contact unit MK are able to be opened, but not closed, by the control unit SE, this being indicated by an arrow from the control unit SE to the mechanical isolating contact unit MK.

The mechanical isolating contact unit MK is able to be operated using a mechanical handle HH on the circuit breaker device SG in order to switch between manual opening or closing of the contacts KKL, KKN. The mechanical handle HH indicates (specifically through a mechanical connection between the contacts and the handle) the switching state (open or closed) of the contacts of the mechanical isolating contact unit MK on the circuit breaker device.

The mechanical isolating contact unit MK is advantageously designed such that it is possible to (manually) close the contacts using the mechanical handle only after an enable, in particular an enable signal. This is likewise indicated by the arrow from the control unit SE to the mechanical isolating contact unit MK. In other words, the contacts KKL, KKN of the mechanical isolating contact unit MK are able to be closed by the handle HH only when the enable or the enable signal (from the control unit) is present. Without the enable or the enable signal, although the handle HH is able to be actuated, the contacts are not closed (“permanent slider contacts”).

The circuit breaker device SG has a power supply NT, for example a power supply unit. The power supply NT is in particular intended for the control unit SE, this being indicated in FIG. 1 by a connection between the power supply NT and the control unit SE. The power supply NT is (also) connected to the grid-side neutral conductor connection NG and the grid-side phase conductor connection LG. A fuse SS, in particular thermal fuse, or/and switch may advantageously be provided in the connection to the grid-side neutral conductor connection NG (or/and phase conductor connection LG).

In the case of a simple single-pole circuit breaker device, power is supplied by an external power source/further terminals.

The low-voltage circuit may be a three-phase AC circuit having a neutral conductor and three phase conductors. The circuit breaker device may for this purpose be designed as a three-phase variant and for example have further grid-side and load-side phase conductor connections. In the same way, electronic interruption units and current sensor units (possibly further first voltage sensor units) according to the invention are provided between the further grid-side and load-side phase conductor connections. This also applies for contacts of the mechanical isolating contact unit.

The signaling output may then be used to communicate the states of one, two or all three electronic interruption units, or in particular the device state (ON/OFF/Standby) of the circuit breaker device, in which case the states of all electronic interruption units are considered together in the signaling signal at the signaling output.

A high-resistance state is understood to mean a state in which only a current of negligible magnitude flows. High-resistance resistance values are in particular understood to mean those greater than 1 kiloohm, better still greater than 10 kiloohms, 100 kiloohms, 1 megaohm, 10 megaohms, 100 megaohms, 1 gigaohm or more.

A low-resistance state is understood to mean a state in which the current value indicated on the circuit breaker device could flow. Low-resistance resistance values are in particular understood to mean those less than 10 ohms, better still less than 1 ohm, 100 milliohms, 10 milliohms, 1 milliohm or less.

The mechanical isolating contact unit MK may perform single-pole interruption in a first variant. In other words, only one conductor (of the two/more) conductors, in particular the active conductor or phase conductor, is interrupted, that is to say has a mechanical contact. The neutral conductor is then free from contact, that is to say the neutral conductor is not connected directly.

If further active conductors/phase conductors are provided, in a second variant, the phase conductors have mechanical contacts of the mechanical isolating contact unit. In this second variant, the neutral conductor is connected directly. This is the case for example for a three-phase AC circuit.

In a third variant of the mechanical isolating contact unit MK, the neutral conductor likewise has mechanical contacts, as illustrated in FIG. 1.

A mechanical isolating contact unit MK is understood to mean in particular a (standard-compliant) isolating function, performed by the isolating contact unit MK. Isolating function is understood to mean the following points:
minimum clearance in air according to standards (minimum distance between the contacts),
contact position indication for the contacts of the mechanical isolating contact unit,
free tripping, that is to say actuation for the purpose of interrupting the contacts of the mechanical isolating contact unit using the handle or control unit is always possible, and so (permanent) blocking of the contacts in the closed state by the handle is not possible.

With regard to the minimum clearance in air between the contacts of the isolating contact unit, this is essentially voltage-dependent. Other parameters are the pollution degree, the type of field (homogeneous, inhomogeneous) and air pressure or height above sea level.

There are corresponding rules or standards for these minimum clearances in air or creepage paths. These rules stipulate for example, in the case of air for a surge withstand capability, the minimum clearance in air for an inhomogeneous and a homogeneous (ideal) electric field on the basis of the pollution degree. The surge withstand capability is the withstand capability when a corresponding surge voltage is applied. The isolating contact unit or circuit breaker device has an isolating function (isolator property) only in the presence of this minimum length (minimum clearance in air).

Within the scope of the invention, the DIN EN 60947 and IEC 60947 series of standards are relevant to the isolator function and the properties thereof in this case, to which standards reference is made here.

The isolating contact unit is advantageously characterized by a minimum clearance in air between the open isolating contacts in the OFF position (open position, open contacts) on the basis of the rated impulse withstand voltage and the pollution degree. The minimum clearance in air is in particular between (at least) 0.01 mm and 14 mm. The minimum clearance in air is in particular advantageously between 0.01 mm at 0.33 kV and 14 mm at 12 kV, in particular for pollution degree 1 and in particular for inhomogeneous fields.

Advantageously, the minimum clearance in air may have the following values:

TABLE 13
Minimum clearances in air
E DIN EN 60947-1 (VDE 0660-100): 2018-06

| | Minimum clearances | | | | | | | |
|---|---|---|---|---|---|---|---|---|
| | mm | | | | | | | |
| Rated | Case A | | | | Case B | | | |
| impulse | Inhomogeneous | | | | Homogeneous field | | | |
| withstand | field conditions | | | | ideal conditions | | | |
| voltage | (see 3.7.63) | | | | (see 3.7.62) | | | |
| Uᵢₘₚ | Pollution degree | | | | Pollution degree | | | |
| kV | 1 | 2 | 3 | 4 | 1 | 2 | 3 | 4 |
| 0.33 | 0.01 | | | | 0.01 | | | |
| 0.5 | 0.04 | 0.2 | | | 0.04 | 0.2 | | |
| 0.8 | 0.1 | | 0.8 | | 0.1 | | 0.8 | 1.6 |
| 1.5 | 0.5 | 0.5 | | 1.6 | 0.3 | 0.3 | | |
| 2.5 | 1.5 | 1.5 | 1.5 | | 0.6 | 0.6 | | |
| 4.0 | 3 | 3 | 3 | 3 | 1.2 | 1.2 | 1.2 | |
| 6.0 | 5.5 | 5.5 | 5.5 | 5.5 | 2 | 2 | 2 | 2 |
| 8.0 | 8 | 8 | 8 | 8 | 3 | 3 | 3 | 3 |
| 12 | 14 | 14 | 14 | 14 | 4.5 | 4.5 | 4.5 | 4.5 |

NOTE
The values of minimum clearances in air are based on 1.2/50 μs impulse voltage, for barometric pressure of 80 kPa, equivalent to normal atmospheric pressure at 2 000 m above sea level.

The pollution degrees and field types correspond to those defined in the standards. This advantageously makes it possible to achieve a standard-compliant circuit breaker device dimensioned in accordance with the rated impulse withstand voltage.

A mechanical isolating contact unit is in particular not understood to mean a relay contact.

FIG. 2 shows an illustration according to FIG. 1, with further or other units being illustrated.

In FIG. 2, the power supply NT is part of the control unit SE. Provision is furthermore made for an (in particular wireless) communication unit COM, which is connected to the control unit SE or is part thereof.

Provision is furthermore made for a display unit AE. The display unit AE may be designed as a combined display and input unit. The display unit AE (display and input unit) is connected to the control unit SE or is part thereof. The display unit has display means that are visible on the circuit breaker device, in particular for displaying the high-resistance or low-resistance state of the electronic interruption unit EU.

The electronic interruption unit EU is part of the control unit SE according to FIG. 2.

According to FIG. 2, the control unit SE may have a microcontroller MP (microcontroller unit). The microcontroller may have various functions or routines/methods, such as for example a configuration function KF, a status signal function Ss, a fault status function FS and a device status function DS.

Provision may furthermore be made for a position sensor unit PD that signals the position of the contacts of the mechanical isolating contact unit (open, closed). The position sensor unit PD is advantageously connected to the control unit SE.

The circuit breaker device SG operates for example in principle such that, when the contacts of the mechanical isolating contact unit are closed and the interruption unit is in the low-resistance state and
in the event of an ascertained current that exceeds a first current value, in particular whereby the first current value is exceeded for a first time limit, the electronic interruption unit EU changes to the high-resistance state and the mechanical isolating contact unit MK remains closed, or/and
(or/and) in the event of an ascertained current that exceeds a higher second current value, in particular for a second time limit, the electronic interruption unit EU changes to the high-resistance state and the mechanical isolating contact unit MK is opened, or/and
in the event of an ascertained current that exceeds an even higher third current value, the electronic interruption unit changes to the high-resistance state and the mechanical isolating contact unit MK is opened.

An external control or display unit ECU or management system may be connected to the signaling output SO, as illustrated in FIG. 2.

FIG. 3 shows the basic structure of a galvanically isolated signaling output SO in connection with an external control unit ECU.

FIG. 3 shows a signaling output SO that is accessible on the housing side. It has multiple connection terminals, two connection terminals AK1, AK2 in the example, wherein the two connection terminals AK1, AK2 are connected, inside the circuit breaker device, to at least one optocoupler OPK or relay (to the switched relay contacts). The optocoupler OPK is also actuated by an (internal) signaling signal MSI, in particular from the control unit SE or its microcontroller MP. The signaling signal MSI may change between a logic zero and one signal or zero and one level {0,1}. The zero signal 0 may for example be zero volts/0 volts 0 V. The one signal may for example be 3.3 volts 3.3 V. It is thus possible to change between zero volts 0 V at one connection (for example ground connection) and between zero volts 0 V and 3.3 volts 3.3 V at the other connection, that is to say {0 V; 3.3 V}, and the logic signal changes between zero and one {0,1}.

The two connection terminals AK1, AK2 are for example connected, on the outside of the housing, to a two-wire line, having a first conductor LT1 and a second conductor LT2. The two-wire line is also connected to an external control unit ECU. The external control unit ECU may for example use a current flow Ix (current source or voltage source) to ascertain the signal state/switching state of the signaling output SO (low-resistance or high-resistance optocoupler output or closed or open relay contact).

FIG. 4 shows a further embodiment of the invention, a function group for the microcontroller MP. The microcontroller MP has a connection to the signaling output SO, to which the internal signaling signal MSI is supplied. This comes from the status signal function SS. The status signal function SS for its part receives information from the fault status function FS and the device status function DS. The device status function DS provides for example the high-resistance or low-resistance state of the electronic interruption unit EU. It may furthermore provide the open or closed state of the contacts of the mechanical isolating contact unit MK. The device status function DS thus provides the device status (ON/OFF/Standby) of the circuit breaker device.

The fault status function FS may for example provide further states of the electrical low-voltage circuit, such as the presence of an overcurrent condition, short-circuit condition, ground fault current, overvoltage or undervoltage condition.

Provision may furthermore be made for a device warning function DW. This may provide further device warnings, such as for example an increased temperature of the circuit breaker device (exceedance of first or/and second temperature limit values).

The configuration function KF makes it possible to define or configure what information is signaled and how.

Checking functions on the circuit breaker device side that
a) switch the electronic interruption unit, which is in the high-resistance state, to the low-resistance state for a first time period or (and)
b) switch the electronic interruption unit, which is in the low-resistance state, to the high-resistance state for a second time period
are not signaled by the signaling output SO.

These brief switching operations may be used for example to test the electronic interruption unit, in particular its semiconductor-based switching elements, or to check the functionality of the current sensor unit.

These brief switching operations are prioritized by the control unit SE such that they are not signaled by the signaling output SO. In other words, the internal signaling signal MSI does not signal this. By way of example, only the “regular” state of the electronic interruption unit or the state derived therefrom of the circuit breaker device is signaled, without the brief switching operations of the circuit breaker device-side (internal) checking functions. As an alternative or in addition, this may also be applied to external protective functions in which for example load or line parameters are ascertained through brief switching operations of the electronic interruption unit.

FIG. 5 indicates, by way of example, the signaling of states of the circuit breaker device SG by way of the signaling output SO. The circuit breaker device, on account of the electronic interruption unit EU and the mechanical isolating contact unit MK, is essentially able to adopt three states:
1. Mechanical isolating contact unit MK open (the at least one contact is open) (state of the electronic interruption unit high-resistance or low-resistance)—state OFF
2. Mechanical isolating contact unit MK closed (the at least one contact is closed) and the electronic interruption unit is in the high-resistance state—state Standby
3. Mechanical isolating contact unit MK closed (the at least one contact is closed) and the electronic interruption unit is in the low-resistance state—state ON (OFF, Standby and ON are reference signs in the drawings).

The signaling output SO may be used for example to communicate physical static information status signals in the form of a one 1 or zero 0 {1; 0}. It is thus possible to communicate two switching states or device states (ON/OFF/Standby). It is possible for example to configure what information should be signaled thereby.

Depending on the configuration, the following may for example be output via the signaling output SO:
in the upper illustration of FIG. 5:
   state OFF—for example switching state zero 0
   state ON and Standby—for example switching state one 1 (conventional, similar to a miniature circuit breaker)
zero 0 and one 1 could also be used the other way round.
in the middle illustration of FIG. 5:
   state OFF and Standby—for example switching state zero 0
   state ON—for example switching state one 1
(zero 0 and one 1 could also be used the other way round.)
in the lower illustration of FIG. 5:
   state OFF—for example switching state zero 0
   state ON—for example switching state one 1
   state Standby—for example a sequence of zero 0 and one 1
(zero 0 and one 1 could also be used the other way round.)

For the lower illustration of FIG. 5, the switching state of the signaling output SO over time t is visualized/illustrated once again in FIG. 6 (sequence examples).

In the upper illustration of FIG. 6:
state OFF—for example zero 0 or zero percent 0%

In the middle illustration of FIG. 6:
state ON—for example one 1 or 100 percent 100%

In the lower illustration of FIG. 6:
state Standby—for example a sequence of switching states zero 0 and one 1, wherein the durations of zero and one are the same, that is to say 50 percent 50%.

The signaling output SO may thus for example be used to communicate even more states or information. This is indicated in FIG. 7.

FIG. 7 illustrates the status signal function SS, which receives the status ON, Standby, OFF, fault status 1 FS1, fault status 2 FS2, device warning 1 DW1.

The fault status FS1 and FS2 may for example be:
short-circuit condition KS achieved
overcurrent condition US achieved
fault current condition achieved
overvoltage condition achieved
undervoltage condition achieved.

The device warning 1 DW1 may for example be:
excessive temperature condition achieved
self-test of the circuit breaker device negative

The signaling of these switching states by way of the signaling output SO is indicated by way of example in FIG. 8. FIG. 8 shows an illustration according to FIG. 6, with the difference that further signaling sequences are illustrated, characterized by specific pulse pause ratios PPV between zero and one signal or zero and one level. FIG. 7 thus illustrates a further switching state/sequence 25 percent 25%, in which the one signal makes up 25 percent of a time unit and the zero signal makes up 75 percent of the time unit, as illustrated in FIG. 8. A fault status 1 FS1 is linked for example to this sequence and signals for example the fact that a short-circuit condition KS of the conductors of the low-voltage circuit, for example more specifically on the load-side connections, has been achieved. By way of example, a short-circuit condition may be the fact that the level of the current has exceeded a (previously defined/set) short-circuit current value.

FIG. 7 also illustrates a further switching state/sequence 75 percent 75%, in which the one signal makes up 75 percent of the time unit and the zero signal makes up 25 percent of the time unit, as illustrated in FIG. 8. A fault status 2 FS2 is linked for example to this sequence and signals for example the fact that an overcurrent condition US of the conductors of the low-voltage circuit, for example more specifically on the load-side connections, has been achieved. By way of example, an overcurrent condition may be the fact that a current threshold value (RMS value or instantaneous threshold value) has been exceeded.

In other words, the signaling output SO has for example two (static) switching states that are able, depending on the information to be signaled, to be output virtually statically or as an alternating state sequence, that is to say (switching) sequence. As an alternative or in addition to the static switching state, a (switching) sequence with a certain pulse pause ratio PPV may be output, such that it is possible to signal (output) more than two items of information.

The invention will be explained again in other words below.

In recent electronic circuit breaker devices, a mechanical isolating contact unit (isolating contacts) is used in combination with an electronic interruption unit (electronic switches). A programmable microcontroller is also used to carry out the protective switching functions, and optionally further device functions. Such a novel circuit breaker device is able to carry out a large number of functions, protect against various faults and adopt multiple states. According to the invention, this should be made to be able to be communicated or signaled using a (parameterizable) signaling contact.

The circuit breaker device carries out various protective functions, such as for example short-circuit protection, overload protection, differential fault current protection (RCD, additional differential current measurement not illustrated), protection against overvoltage, undervoltage or excessive temperature (additional temperature measurement, not illustrated). A handle (for opening and closing the isolating contact unit), detection of the handle (or better still of the isolating contact)—a position sensor unit, current measurement, voltage measurement and a power supply are present, for example. According to the invention, provision is made for an in particular galvanically isolated signaling output (signaling contact). This signaling output may be designed like a floating switch actuated via the control unit or the microcontroller. This signaling output (signaling contact) may be used by the circuit breaker device to provide information about the switching state of the device, in particular of the electronic interruption unit, in a simple digital form (0, 1).

The galvanically isolated signaling output may for example be implemented by an optocoupler having corresponding galvanic isolation. An external (separate) control unit ECU may for example query the switching state of the signaling output (switching state at the output of the optocoupler) via a current or voltage source.

The signaling output may signal multiple items of information. In addition to the known states ON and OFF, there may be the state Standby. In addition to the abovementioned states, the signaling output may also be used to signal (transmit) a fault status or a (device) warning of the circuit breaker device.

The items of information are present in the microcontroller MP. Depending on the (set) configuration, a desired item of information may be output, wherein the type of the item of information that is output (status, sequence) may also be configured.

In addition to basic switching states, further information may also be signaled (communicated) via the signaling output. For example, fault types, such as for example short circuit, overload or fault current, may be signaled.

The sequences may be defined and varied both in terms of pulse pause ratio PPV (duty cycle) and in terms of frequency and signal sequence.

According to the invention, provision is thus advantageously made for a single signaling output (signaling contact) that is integrated in the circuit breaker device and that is able to be used and configured for various information, such as for example device states. The signaling output may advantageously be configured such that in particular fault states on the load-side connection are able to be signaled (communicated) by definable sequences.

Although the invention has been described and illustrated in more detail by the exemplary embodiment, the invention is not restricted by the disclosed examples and other variations may be derived therefrom by a person skilled in the art without departing from the scope of the invention.

1-13. (canceled)

14. A circuit breaker device for protecting an electrical low-voltage circuit, the circuit breaker device comprising:
a housing having at least one grid-side connection and at least one load-side connection for conductors of the electrical low-voltage circuit;
a series circuit having a mechanical isolating contact unit connected in series with an electronic interruption unit, wherein said series circuit is connected to said at least one grid-side connection and to said at least one load-side connection, wherein said mechanical isolating contact unit has contacts and is switched by opening at least one of said contacts so as to avoid a current flow or closes said at least one contact to allow the current flow in the electrical low-voltage circuit, wherein said electronic interruption unit has semiconductor-based switching elements and is able to be switched by said semiconductor-based switching elements to a high-resistance state of said semiconductor-based switching elements so as to avoid the current flow or to a low-resistance state of said semiconductor-based switching elements so as to allow the current flow in the electrical low-voltage circuit;
a current sensor unit for ascertaining a level of a current in the electrical low-voltage circuit;
a controller connected to said current sensor unit, said mechanical isolating contact unit and said electronic interruption unit, wherein, in an event of current and/or current-time limit values being exceeded, avoidance of the current flow in the electrical low-voltage circuit is initiated; and
a signaling output being accessible on said housing of the circuit breaker device, wherein the circuit breaker device is configured such that said signaling output signals the high-resistance state or the low-resistance state of said electronic interruption unit.

15. The circuit breaker device according to claim 14, wherein said mechanical isolating contact unit is assigned to said at least one load-side connection and said electronic interruption unit is assigned to said at least one grid-side connection.

16. The circuit breaker device according to claim 14, wherein said at least one grid-side connection is one of two grid-side connections.

17. The circuit breaker device according to claim 14, wherein:
said at least one grid-side connection is one of two grid-side connections; and
said at least one load-side connection is one of two load-side connections.

18. The circuit breaker device according to claim 14, wherein said signaling output has safe galvanic isolation.

19. The circuit breaker device according to claim 14, wherein said signaling output also signals an open or closed state of at least one of said contacts of said mechanical isolating contact unit.

20. The circuit breaker device according to claim 14,
further comprising at least one isolating switching element; and
wherein said signaling output has a plurality of connection terminals, said connection terminals are connected, inside the circuit breaker device, to said at least one isolating switching element.

21. The circuit breaker device according to claim 14, wherein the circuit breaker device is configured such that said signaling output is configurable and, in addition to signaling the high-resistance state or the low-resistance state of said electronic interruption unit or as an alternative therein, also signals:
a) a presence of an electrical fault on said at least one load-side connection; and/or
b) a presence of a fault inside the circuit breaker device.

22. The circuit breaker device according to claim 21, wherein:
the electrical fault on said at least one load-side connection is:
a) a short circuit; and/or
b) an overload; and/or
c) a ground fault current;
the fault inside the circuit breaker device is:
a) an excessive device temperature; and/or
b) a current threshold value being exceeded or fallen below; and/or
c) a voltage threshold value being fallen below or exceeded.

23. The circuit breaker device according to claim 14, wherein the circuit breaker device is configured such that said signaling output is able to adopt two switching states, which may also be output as a sequence, such that it is possible to output multiple items of information via said signaling output.

24. The circuit breaker device according to claim 23, wherein the circuit breaker device is configured such that the switching states or sequences are configurable, including such that a respective state of said electronic interruption unit, of said mechanical isolating contact unit, a fault on said at least one load-side connection or a fault in-side the circuit breaker device is able to be assigned to a switching state or a sequence.

25. The circuit breaker device according to claim 14, wherein checking functions on the circuit breaker device side that:
a) switch said electronic interruption unit, which is in the high-resistance state, to the low-resistance state for a first time period; or
b) switch said electronic interruption unit, which is in the low-resistance state, to the high-resistance state for a second time period;
are not signaled by said signaling output.

26. The circuit breaker device according to claim 15, wherein said mechanical isolating contact unit has a mechanical handle and is configured to operate using said mechanical handle to switch between opening said contacts or closing said contacts.

27. The circuit breaker device according to claim 23, wherein said signaling output has two connection terminals.

28. The circuit breaker device according to claim 20, wherein:
said plurality of connection terminals of said signaling output is two connection terminals or three connection terminals; and
said at least one isolating switching element is an optocoupler or relay contact.

29. A method for operating a circuit breaker device for protecting an electrical low-voltage circuit, the electrical low-voltage circuit having:
a series circuit having a mechanical isolating contact unit connected in series with an electronic interruption unit, wherein the series circuit is connected to at least one grid-side connection and to at least one load-side connection, wherein the mechanical isolating contact unit is switched by opening contacts so as to avoid a current flow or closing the contacts to allow the current flow in the electrical low-voltage circuit, wherein the electronic interruption unit is able to be switched by semiconductor-based switching elements to a high-resistance state of the semiconductor based switching elements so as to avoid the current flow or a low-resistance state of the semiconductor-based switching elements so as to allow the current flow in the electrical low-voltage circuit;
which comprises the steps of:
ascertaining a level of a current in the electrical low-voltage circuit;
initiating avoidance of the current flow in the electrical low-voltage circuit in an event of current and/or current-time limit values being exceeded; and
signaling the high-resistance state or the low-resistance state of the electronic interruption unit via a signaling output.
